(19) United States
(12) Patent Application Publication
(10) Pub. No.: US 2014/0195951 A1
(43) Pub. Date: Jul. 10, 2014

(54) METHOD FOR MANAGING SCHEDULE AND ELECTRONIC DEVICE THEREOF

(71) Applicant: Samsung Electronics Co. Ltd., Suwon-si (KR)

(72) Inventors: Sun-Kee LEE, Seongnam-si (KR); Yong-Joon JEON, Hwaseong-si (KR); Kwang-Weon PARK, Yongin-si (KR)

(73) Assignee: Samsung Electronics Co. Ltd., Suwon-si (KR)

(21) Appl. No.: 14/082,597

(22) Filed: Nov. 18, 2013

(30) Foreign Application Priority Data
Jan. 7, 2013 (KR) 10-2013-0001607

(51) Int. Cl. G06F 3/0484; G06F 3/0488

(52) U.S. Cl. CPC G06F 3/0484; G06F 3/0488
USPC 715/771

(57) ABSTRACT

A method for controlling an electronic device is provided. The method includes detecting a first schedule and a second schedule, detecting at least one task, detecting at least one location corresponding to the task within a threshold distance of a location associated with the first schedule and a location associated with the second schedule, calculating an estimated time to travel from the location associated with the first schedule to the location associated with the second schedule using the at least one detected location, comparing the calculated estimated time with a time difference between a completion time of the first schedule and a start time of the second schedule, and outputting information about the at least one detected location when the calculated estimated time is smaller than the time difference.

### CROSS-REFERENCE TO RELATED APPLICATION(S)

This application claims the benefit under 35 U.S.C. §119 of a Korean patent application filed on Jan. 7, 2013 in the Korean Intellectual Property Office and assigned Serial No. 10-2013-0001607, the entire disclosure of which is hereby incorporated by reference.

### TECHNICAL FIELD

The present disclosure relates to an electronic device. More particularly, the present disclosure relates to a method for scheduling in the electronic device and the electronic device thereof.

### BACKGROUND

As a result of the recent rapid development of electronic devices, such as, for example, smart phones and tablet personal computers, electronic devices capable of performing wireless voice communication and information exchange have become necessities to users. At an early stage in the development of electronic devices, electronic devices were recognized as portable devices capable of merely performing wireless voice communication. However, with the development of technology and the introduction of wireless Internet, electronic devices have evolved from portable device capable of merely performing wireless voice communication into multimedia devices capable of performing functions such as for example, a schedule management function, a gaming function, a remote control function, an image capture function, and a projector function.

In particular, an electronic device provides an application for helping schedule management. Such an application provides a service for generating an alarm at a time set by a user. For example, when a schedule of “meeting at a company from 09:00 to 11:00” is stored in the electronic device, the electronic device provides an alarm service for the schedule at 09:00 or before 09:00. As another example, when a schedule of “studying at home from 14:00 to 15:00” is stored, the electronic device provides an alarm service for the schedule at 14:00 or before 14:00.

However, such a schedule management application according to the related art merely stores a schedule content input by a user and provides an alarm service at a set alarm time. As a result, a schedule management application does not manage a schedule in the application and/or does not provide a schedule management service. For example, when the user wants to manage tasks other than schedules in a schedule application, the user should add a memo to the schedule application and set an alarm to receive provision of an alarm service or should execute the memo personally whenever necessary, thus inconveniencing the user.

Therefore, there is a need to provide an application for efficiently manage schedules of a user in the application.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages below. Accordingly, an aspect of the present disclosure is to provide an apparatus and method for managing a schedule in an electronic device.

Another aspect of the present disclosure is to provide an apparatus and method for relating a schedule with a task in an electronic device.

Another aspect of the present disclosure is to provide an apparatus and method for searching for a task that is performable between a first schedule and a second schedule in an electronic device.

Another aspect of the present disclosure is to provide an apparatus and method for providing information about a task that is performable between a first schedule and a second schedule in consideration of locations and times of a first schedule and a second schedule in an electronic device.

In accordance with an aspect of the present disclosure, a method for controlling an electronic device is provided. The method includes detecting a first schedule and a second schedule, detecting at least one task, detecting at least one location corresponding to the task within a threshold distance of a location associated with the first schedule and a location associated with the second schedule, calculating an estimated time to travel from the location associated with the first schedule to the location associated with the second schedule using the at least one detected location, comparing the calculated estimated time with a time difference between a completion time of the first schedule and a start time of the second schedule, and outputting information about the at least one detected location when the calculated estimated time is smaller than the time difference.

In accordance with another aspect of the present disclosure, an electronic device is provided. The electronic device includes at least one processor, a touch sensitive display, a memory, and at least one program stored in the memory and configured to be executable by the at least one processor, wherein the at least one program includes instructions for: detecting a first schedule and a second schedule, detecting at least one task, detecting at least one location corresponding to the task within a threshold distance of a location associated with the first schedule and a location associated with the second schedule, calculating an estimated time taken to travel from the location associated with the first schedule to the location associated with the second schedule using the at least one detected location; comparing the calculated estimated time with a time difference between a completion time of the first schedule and a start time of the second schedule, and outputting information about the at least one detected location when the calculated estimated time is smaller than the time difference.

In accordance with another aspect of the present disclosure, a method for controlling an electronic device is provided. The method includes detecting a first schedule and a second schedule, and outputting information about a task that is performable between the first schedule and the second schedule among a plurality of tasks stored in the electronic device, when the first schedule is completed, wherein the information about the task includes at least one of at least one location at which performance of the task is possible, and an available time for task performance.

In accordance with another aspect of the present disclosure, an electronic device is provided. The electronic device includes at least one processor, a touch sensitive display, a memory, and at least one program stored in the memory and configured to be executable by the at least one processor, wherein the at least one program includes instructions for: detecting a first schedule and a second schedule, and outputting information about a task that is performable between the first schedule and the second schedule among a plurality of tasks stored in the electronic device, when the first schedule is completed, wherein the information about the task includes at least one of at least one location at which performance of the task is possible, and an available time for task performance.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram illustrating a block configuration of an electronic device for managing a schedule according to an embodiment of the present disclosure;

FIG. 1B is a diagram illustrating a block configuration of a processor for managing a schedule according to an embodiment of the present disclosure;

FIG. 2 is a diagram illustrating a process of managing a schedule in an electronic device according to an embodiment of the present disclosure;

FIGS. 3A and 3B are diagrams illustrating a process for providing information about a task that is performable between a first schedule and a second schedule in an electronic device according to an embodiment of the present disclosure;

FIG. 4 is a diagram illustrating an example of managing a schedule and a task in an electronic device according to an embodiment of the present disclosure;

FIG. 5 is a diagram illustrating a location of a performable task between a first schedule and a second schedule in an electronic device according to an embodiment of the present disclosure;

FIG. 6 is a diagram illustrating a location of a performable task when location information is included in a task in an electronic device according to an embodiment of the present disclosure; and

FIG. 7 is a diagram illustrating a location of a performable task when location information is not included in a task in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As a non-exhaustive illustration only, according to various embodiments of the present disclosure, the electronic device may refer to a mobile communication terminal including a schedule management application, a smart phone, a tablet Personal Computer (PC), a Personal Digital Assistant (PDA), a digital camera, a portable game console, a Portable/Personal Multimedia Player, a handheld e-book, a portable laptop PC, a Global Positioning System (GPS) navigation, an MP3 player, and/or the like, and devices such as a desktop PC, a high definition television (HDTV), an optical disc player, a set-top box, and the like capable of wireless communication or network communication consistent with that disclosed herein.

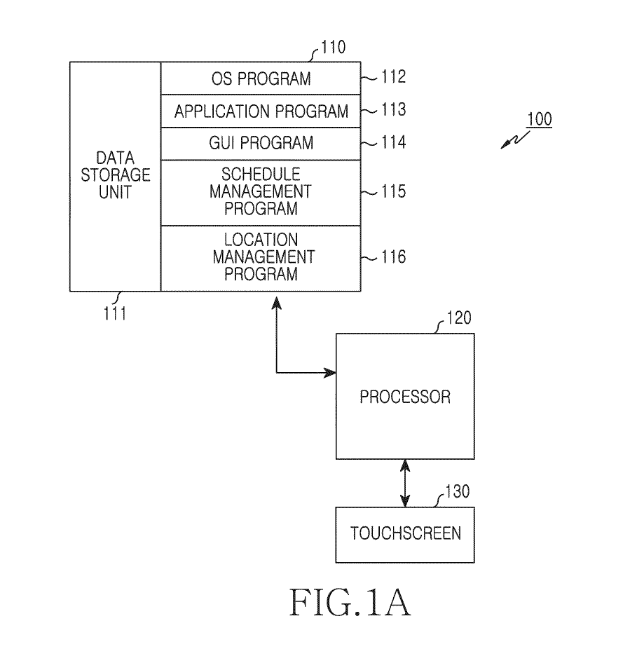

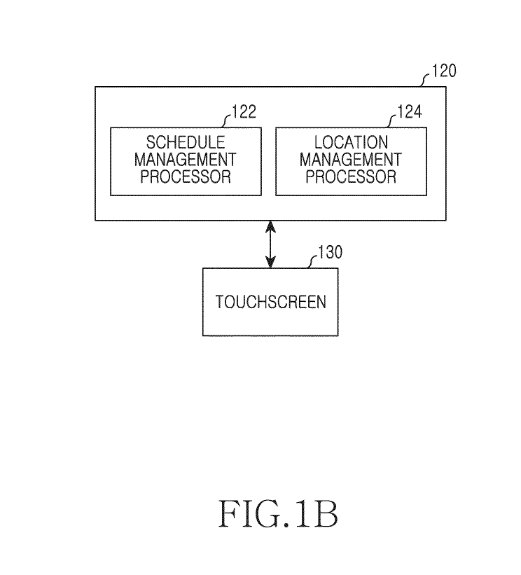

FIG. 1A illustrates a block configuration of an electronic device for managing a schedule according to an embodiment of the present disclosure.

Referring to FIG. 1A, the electronic device 100 includes a memory 110, a processor 120, and a touchscreen 130. According to various embodiments of the present disclosure, the electronic device 100 may include a plurality of memories 110, and/or a plurality of processors 120.

For example, the memory 110 includes a data storage unit 111, an Operating System (OS) program 112, an application program 113, a Graphic User Interface (GUI) program 114, a schedule management program 115, and a location management program 116. In addition, because the program that is an element of the software may be represented as a set of instructions, the program may be referred to as an instruction set. The program may also be referred to as a module.

The memory 110 may store one or more programs including instructions for performing various embodiments of the present disclosure.

The data storage unit 111 stores data generated during the performance of a function corresponding to the program stored in the memory 110. For example, according to various embodiments of the present disclosure, the data storage unit 111 may store a schedule and a task. Herein, the schedule includes time and location information, and refers to activities, items and/or the like to do by a user. In addition, the task may include any one or none of time and location information, and refers to items and/or the like to be by the user. For example, the data storage unit 111 may store a task (schedule) that includes a description “meeting at company 09:00 to 11:00”. As another example, the data storage unit 111 may store a task including a description “purchasing a computer”.

In addition, the data storage unit 111 provides a navigation service based on real-time traffic information and stores a Transport Protocol Expert Group (TPEG) used to calculate an estimated travel time. In addition, the data storage unit 111 may store map information including location information about buildings around roads and Point of Interest (POI) information.

The OS program 112 (e.g., WINDOWS, LINUX, Darwin, RTXC, UNIX, OS X, or an embedded OS such as VxWorks) includes various software components for controlling general system operations. For example, general system operation controls may include memory control/management, storage hardware (device) control/management, and power control/management. The OS program 112 also performs a function for enabling smooth communication between various hardware components (devices) and software components (programs).

The application program 113 includes a browser application, an e-mail application, a message application, a word processing application, an address book application, a widget application, a Digital Right Management (DRM) application, a voice recognition application, a voice replication application, a position determining function application, a Location-Based Service (LBS) application, a telephone application, a schedule and task management application, and/or the like.

The GUI program 114 includes at least one software component for providing a graphic user interface between a user and the electronic device 100. For example, the GUI program 114 includes at least one software component for displaying user interface information on the touchscreen 130. According to various embodiments of the present disclosure, the GUI program 114 includes instructions for displaying at least one schedule and task which are input by the user. In addition, the GUI program 114 includes instructions for displaying information about at least one location corresponding to a task that is performable between the first schedule and the second schedule. In this case, the GUI program 114 may display an estimated time taken to travel from a location associated with the first schedule to a location corresponding to a particular task and an estimated time taken to travel from the location corresponding to the particular task to a location associated with the second schedule. In addition, the GUI program 114 includes instructions for displaying a time that may be used to perform the particular task and that is obtained (e.g., determined) by subtracting a travel time from the difference in time between the first schedule and the second schedule when the electronic device 100 travels from the location associated with the first schedule to the location associated with the second schedule via the location corresponding to the particular task. For example, when the electronic device 100 travels from the location associated with the first schedule to the location associated with the second schedule via the location corresponding to the particular task, it is possible to display an indication that the time which may be used to perform the particular task is 30 minutes.

The schedule management program 115 manages schedules and tasks stored in the memory. The schedule management program 115 may detect the start time and/or completion time of a schedule. In addition, the schedule management program 115 may provide an alarm at the start time of a schedule, or a predetermined time before the start time. For example, the schedule management program 115 may detect that the start time of the first schedule is 18:00, and provide an alarm at 18:00. As another example, the schedule management program 115 may detect that the start time of the first schedule is 19:00, and provide an alarm at 18:50 (e.g., 10 minutes before 19:00).

In addition, the schedule management program 115 includes instructions for detecting a next schedule after a particular schedule has been completed in cooperation with the location management program 116, for determining a task that is performable before performance of the next schedule among a plurality of tasks stored in the data storage unit 111, and for outputting information about the determined task. For example, when the first schedule and the second schedule are performed time-sequentially, the schedule management program 115 includes instructions for determining the performable task before the start of the second schedule when the first schedule is completed, and for outputting information about the determined task.

The location management program 116 detects at least one location corresponding to a schedule and a task. First, when two schedules are detected by the schedule management program 115, the location management program 116 may determine the location associated with the first schedule and the location associated with the second schedule based on location information included in the schedules. In this case, the location management program 116 may determine the locations associated with the schedules based on previously stored map information and Point Of Interest (POI) information. As another example, the location management program 116 may determine the location associated with a particular task (e.g., the first schedule) by communicating with a server (e.g., a webserver or other web-based service which can look up information included with the particular task).

In addition, the location management program 116 searches for at least one location corresponding to a task within a threshold distance from the determined locations associated with the first schedule and the second schedule. In this case, the at least one location corresponding to the task represents a location at which the task may be performed, and may be determined by searching a higher category of a word included in the task. For example, when the task is “Purchasing a dictionary”, the location management program 116 determines a book as the umbrella concept of a dictionary, and searches for a “Bookstore” at which the dictionary is sold within a threshold distance from the location associated with the first schedule and the location associated with the second schedule. As another example, when the task is “Filling with oil”, the location management program 116 searches for a “gas station” located within the threshold distance from the location associated with the first schedule and the location associated with the second schedule. According to various embodiments of the present disclosure, the location management program 116 may perform the searching by communicating with a server (e.g., a webserver or other web-based service) or by searching a database stored locally in the memory 111.

When the at least one location corresponding to the task is found within the threshold distance from the location associated with the first schedule and the location associated with the second schedule, a location at which the task may be performed between the first schedule and the second schedule is determined among the at least one found location. Specifically, the location management program 116 determines whether the task includes time information, at least one location corresponding to the task exists within the threshold distance from the location associated with the first schedule and the location associated with the second schedule.

When the task includes time information, the location management program 116 determines the time information of the task (hereinafter referred to as a “task time”) and calculates the difference in time (hereinafter referred to as a “first time”) between the completion time of the first schedule and the start time of the second schedule, and an estimated time (hereinafter referred to as a “second time”) taken to travel from the location associated with the first schedule to the location associated with the second schedule via the location corresponding to the task. Thereafter, the location management program 116 determines a location at which the sum of the second time and the task time is smaller than the first time among the at least one location corresponding to the task. When two or more locations at which the sum of the second time and the task time is smaller than the first time exist, the location management program 116 may provide the two locations as options, and provide information about a location selected by the user or a location at which the second time is shortest. In contrast, when one location at which the sum of the second time and the task time is smaller than the first time exists, the location management program 116 provides information about the location. In this case, the information about the location includes a sketch map from the location associated with the first schedule to the location corresponding to the task, and a sketch map from the location corresponding to the task to the location associated with the second schedule. According to various embodiments of the present disclosure, when more than one location at which the sum of the second time and the task time is smaller than the first time exists, selection as to whether the more than one locations are provided as options may be toggled on or off For example, the location management program 116 may provide the closest location, the location for which the second time is shortest, or the like.

In contrast, when the task does not include time information in, the location management program 116 calculates the first time and the second time. Thereafter, the location management program 116 determines a location at which the second time is smaller than the first time among the at least one location corresponding to the task. When two or more locations at which the second time is smaller than the first time exist, the location management program 116 may provide the two locations as options, and provide information about a selected location or a location at which the second time is shortest. In contrast, when one location at which the second time is smaller than the first time exists, the location management program 116 provides information about the location. In this case, the location management program 116 may calculate an available time for task performance and provide information about the calculated available time for task performance. In this case, the available time for task performance is calculated by subtracting the second time from the first time. For example, when the difference in time between the completion time of the first schedule and the start time of the second schedule is an hour and a half, and the estimated time taken to travel from the location associated with the first schedule to the location associated with the second schedule via the location corresponding to the task is a half hour, the location management program 116 may provide information representing that the available time for task performance is an hour.

When the task has been performed, the location management program 116 determines whether another task other than the performed task exists. When another task other than the performed task exists, the location management program 116 determines the location of the performed task as the location associated with the first schedule and the completion time of the performed task as the completion time of the first schedule, and repeatedly performs the above-described procedures.

Although not illustrated, the processor 120 may include at least one processor and a peripheral interface. In addition, the processor 120 executes a specific program (instruction set) stored in the memory 110 and performs a plurality of specific functions corresponding to the program.

The touchscreen 130 is a touch-sensitive display and provides an interface for touch input/output between the electronic device 100 and the user. The touchscreen 130 is a medium that detects a touch (and/or contact) through a touch sensor (not illustrated), transmits the detected touch input to the electronic device 100, and visually provides an output from the electronic device 100 to the user. For example, the touchscreen 130 provides a visual output, such as text, graphic and video, to the user in response to the touch input.

The touchscreen 130 includes a touch-sensitive surface that accepts user input, and detects the user's touch input based on a haptic contact, a tactile contact, a combination thereof, or the like. For example, a touch-detected point on the touchscreen 130 corresponds to the width of a finger used for contact with the touch sensitive surface. In addition, the touchscreen 130 detects a contact of an external device, such as a stylus pen, through the touch sensitive surface. The detected contact is converted into interaction with user-interface objects (e.g., one or more soft keys) that are displayed on the touchscreen.

The touchscreen 130 provides an interface for touch input/output between the electronic device 100 and the user. The touchscreen 130 is a medium that transmits the user's touch input to the electronic device 100 and visually provides an output from the electronic device 100 to the user. The touchscreen 130 may use various display technologies, such as a Liquid Crystal Display (LCD), n Light Emitting Diode (LED), a Light Emitting Polymer Display (LEPD), an Organic Light Emitting Diode (OLED), an Active Matrix Organic Light Emitting Diode (AMOLED), a Flexible LED (FLED), and/or the like. According to various embodiments of the present disclosure, the touchscreen 130 is not limited to touchscreens using the above-identified display technologies. In addition, the touchscreen 130 may detect the start, movement, stop or end of a touch on a touch detection surface by using various touch detection (or sensing) technologies such as capacitive detection, resistive detection, infrared detection, and Surface Acoustic Wave (SAW) detection. According to various embodiments of the present disclosure, the touchscreen 130 may display a location associated with the first schedule, a location associated with the second schedule, and at least one location associated with a task that is performable between the first schedule and the second schedule. In addition, the touchscreen 130 may display a sketch map necessary to travel from the location associated with the first schedule to the location associated with the second schedule via a location corresponding to a specific task. In this case, the touchscreen 130 may display the time information when time information is included in the task, and, display an available time for task performance when time information is not included in the task.

FIG. 1B is a diagram illustrating a block configuration of a processor for managing a schedule according to an embodiment of the present disclosure.

Referring to FIG. 1B, the processor 120 includes a schedule management processor 122 and a location management processor 124.

According to various embodiments of the present disclosure, the schedule management processor 122 manages schedules and tasks stored in the memory. The schedule management processor 122 may detect the start time and/or completion time of a schedule. In addition, the schedule management processor 122 may provide an alarm at the start time of a schedule, or a predetermined time before the start time. For example, the schedule management processor 122 may detect that the start time of the first schedule is 18:00, and provide an alarm at 18:00. As another example, the schedule management processor 122 may detect that the start time of the first schedule is 19:00:00, and provide an alarm at 18:50, (e.g., 10 minutes before 19:00).

In addition, the schedule management processor 122 includes instructions for detecting a next schedule after a particular schedule has been completed in cooperation with the location management processor 124, determining a task that is performable before performance of the next schedule among a plurality of tasks stored in the data storage unit 111, and for outputting information about the determined task. For example, when the first schedule and the second schedule are performed time-sequentially, the schedule management processor 122 includes instructions for determining the performable task before start of the second schedule when the first schedule is completed, and for outputting information about the determined task.

The location management processor 124 detects at least one location corresponding to a schedule and a task. First, when two schedules are detected by the schedule management processor 122, the location management processor 124 may determine the location associated with the first schedule and the location associated with the second schedule based on location information included in the schedules. In this case, the location management processor 124 may determine the locations associated with the schedules based on previously stored map information and Point Of Interest (POI) information.

In addition, the location management processor 124 searches for at least one location corresponding to a task within a threshold distance from the determined locations associated with the first schedule and the second schedule. In this case, the at least one location corresponding to the task represents a location at which the task may be performed, and may be determined by searching a higher category of a word included in the task. For example, when the task is “Purchasing a dictionary”, the location management processor 124 determines a book as the umbrella concept of a dictionary, and searches for a “bookstore” at which the dictionary is sold within the threshold distance from the location associated with the first schedule and the location associated with the second schedule. As another example, when the task is “Filling with oil”, the location management processor 124 searches for a “gas station” located within the threshold distance from the location associated with the first schedule and the location associated with the second schedule.

When the at least one location corresponding to the task is found within the threshold distance from the location associated with the first schedule and the location associated with the second schedule, a location at which the task may be performed between the first schedule and the second schedule is determined among the at least one found location. Specifically, the location management processor 124 determines whether the task includes time information, when at least one location corresponding to the task within the threshold distance from the location associated with the first schedule and the location associated with the second schedule exists.

When the task includes time information, the location management processor 124 determines the time information of the task (hereinafter referred to as a “task time”) and calculates the difference in time (hereinafter referred to as a “first time”) between the completion time of the first schedule and the start time of the second schedule, and an estimated time (hereinafter referred to as a “second time”) taken to travel from the location associated with the first schedule to the location associated with the second schedule via the location corresponding to the task. Thereafter, the location management processor 124 determines a location at which the sum of the second time and the task time is smaller than the first time among the at least one location corresponding to the task. When two or more locations at which the sum of the second time and the task time is smaller than the first time exist, the location management processor 124 may provide the two locations as options, and provide information about a location selected by the user or a location at which the second time is shortest. In contrast, when one location at which the sum of the second time and the task time is smaller than the first time exists, the location management processor 124 provides information about the location. In this case, the information about the location includes a sketch map from the location associated with the first schedule to the location corresponding to the task, and a sketch map from the location corresponding to the task to the location associated with the second schedule. According to various embodiments of the present disclosure, when more than one location at which the sum of the second time and the task time is smaller than the first time exists, selection as to whether the more than one locations are provided as options may be toggled on or off For example, the location management processor 124 may provide the closest location, the location for which the second time is shortest, or the like.

In contrast, when the task does not include time information in the task, the location management processor 124 calculates the first time and the second time. Thereafter, the location management processor 124 determines a location at which the second time is smaller than the first time among the at least one location corresponding to the task. When two or more locations at which the second time is smaller than the first time exist, the location management processor 124 may provide the two locations as options, and provide information about a selected location or a location at which the second time is shortest. In contrast, when one location at which the second time is smaller than the first time exists, the location management processor 124 provides information about the location. In this case, the location management processor 124 may calculate an available time for task performance and provide information about the calculated available time for task performance. In this case, the available time for task performance is calculated by subtracting the second time from the first time. For example, when the difference in time between the completion time of the first schedule and the start time of the second schedule is an hour and a half, and the estimated time taken to travel from the location associated with the first schedule to the location associated with the second schedule via the location corresponding to the task is a half hour, the location management processor 124 may provide information representing that the available time for task performance is an hour.

When the task has been performed, the location management processor 124 determines whether another task other than the performed task exists. When another task other than the performed task exists, the location management processor 124 determines the location associated with the performed task as the location associated with the first schedule and the completion time of the performed task as the completion time of the first schedule, and repeatedly performs the above-described procedures.

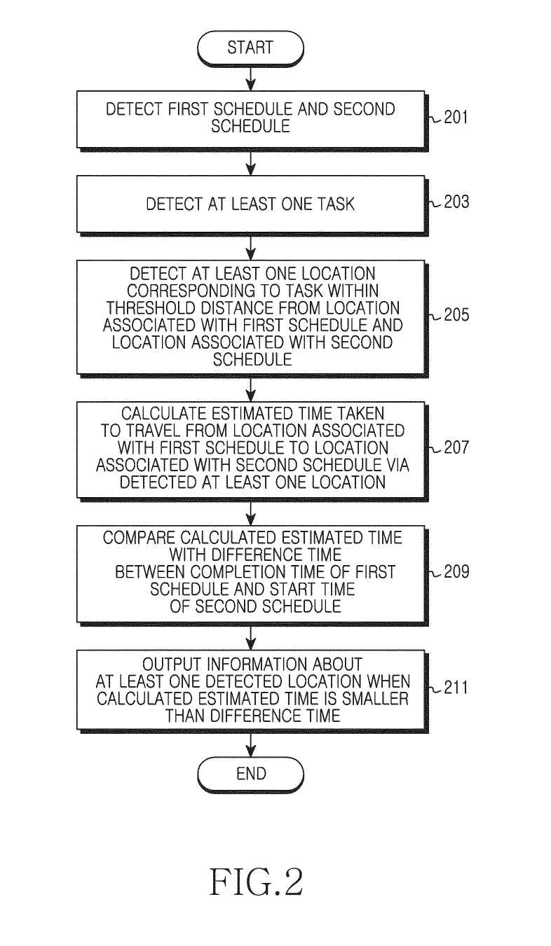

FIG. 2 illustrates a process of managing a schedule in the electronic device 100 according to an embodiment of the present disclosure.

Referring to FIG. 2, at operation 201, the electronic device 100 detects a first schedule and a second schedule.

At operation 203, detects at least one task. Herein, the schedule includes time and location information, and refers to items and/or the like to do by a user. In addition, the task may include any one or none of time and location information, and refers to items and/or the like to be by the user.

Thereafter, at operation 205, the electronic device 100 detects at least one location corresponding to the task within a threshold distance from a location associated with the first schedule and a location associated with the second schedule. In this case, the at least one location corresponding to the task represents a location at which the task may be performed. For example, when the task is “Purchasing a dictionary”, the electronic device 100 detects a “bookstore” at which the dictionary is sold within the threshold distance from the location associated with the first schedule and the location associated with the second schedule.

Thereafter, at operation 207, the electronic device 100 calculates an estimated time taken to travel from the location associated with the first schedule to the location associated with the second schedule via the at least one detected location. In this case, the electronic device 100 respectively calculates a first estimated time taken to travel from the location associated with the first schedule to the at least one detected location and a second estimated time taken to travel from the at least one detected location to the location associated with the second schedule.

Thereafter, at operation 209, the electronic device 100 compares the calculated estimated time with the difference in time between the completion time and the start time of the second schedule.

At operation 211, the electronic device 100 outputs information about the at least one detected location when the calculated estimated time is smaller than the difference in time. In this case, the electronic device 100 may output the information about the location through the touchscreen 130 or a speaker (not illustrated).

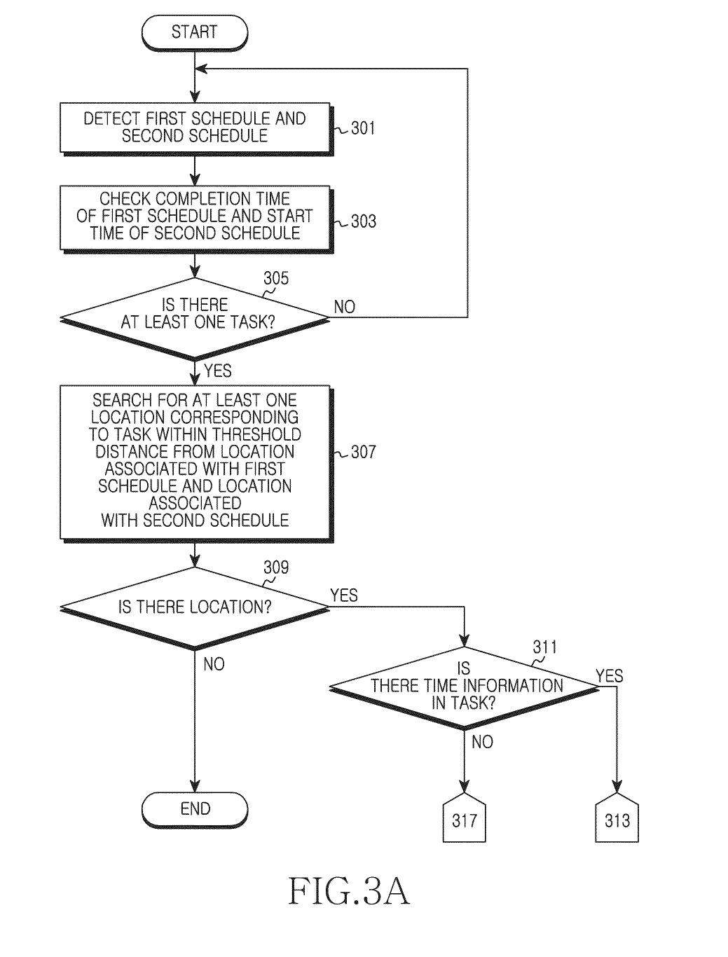

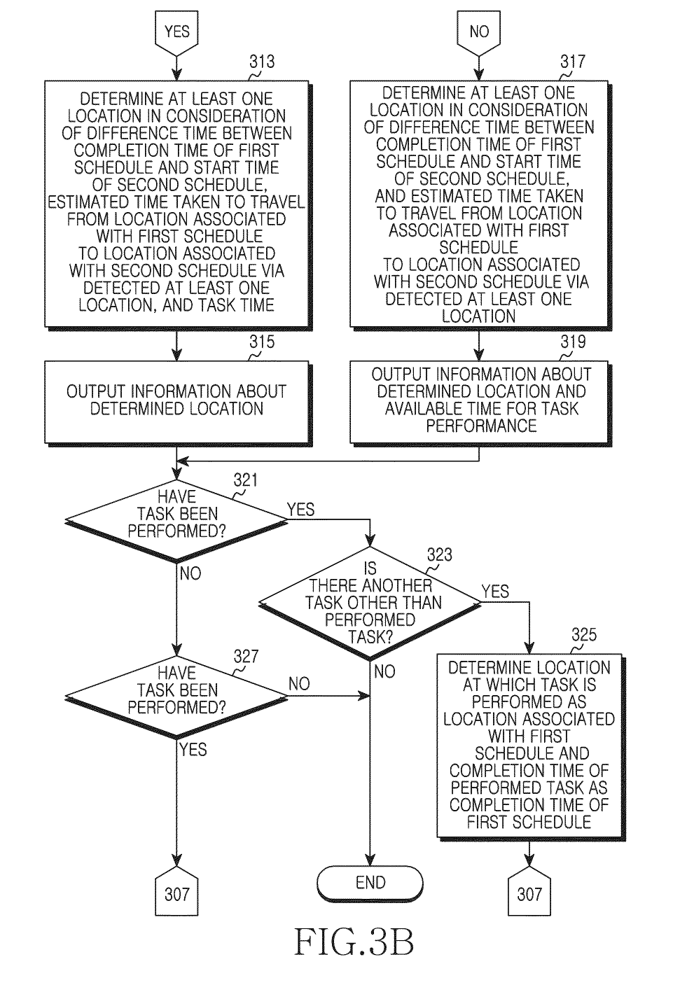

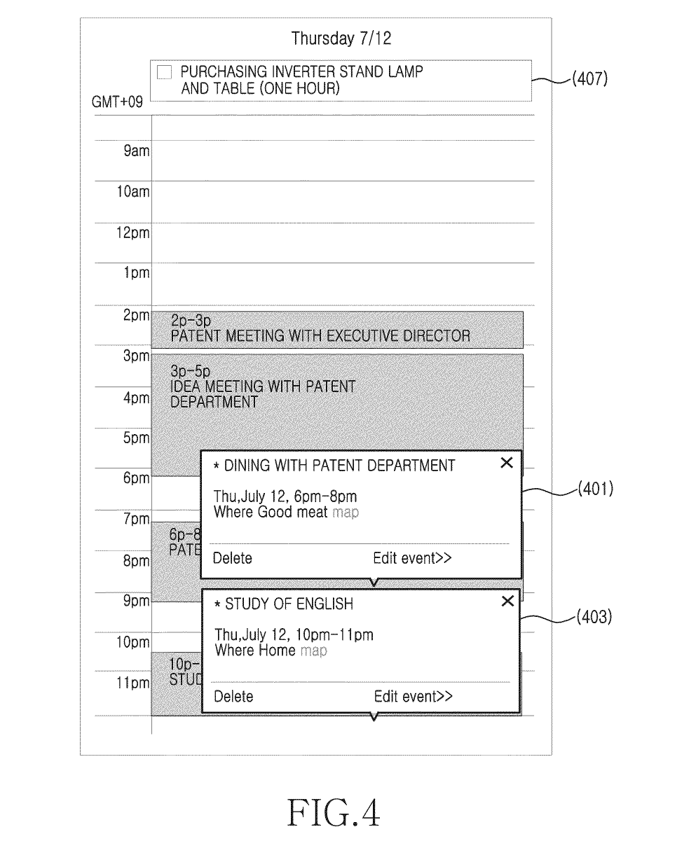

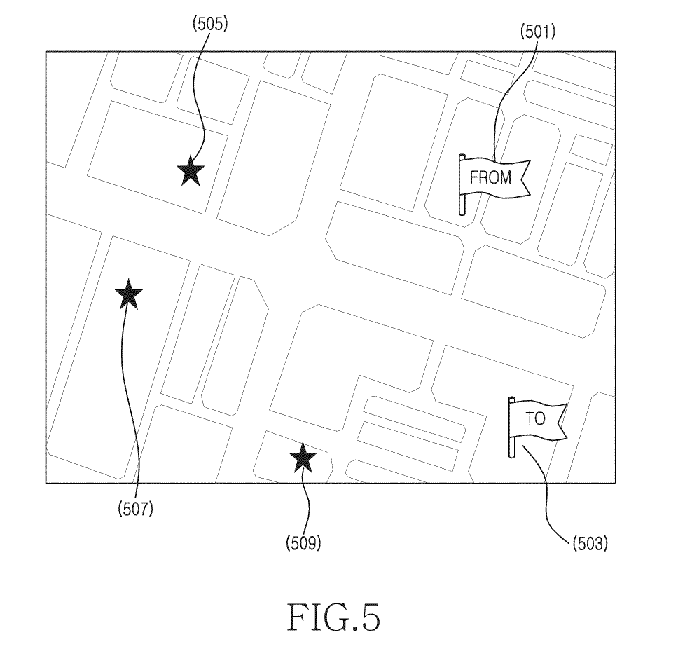

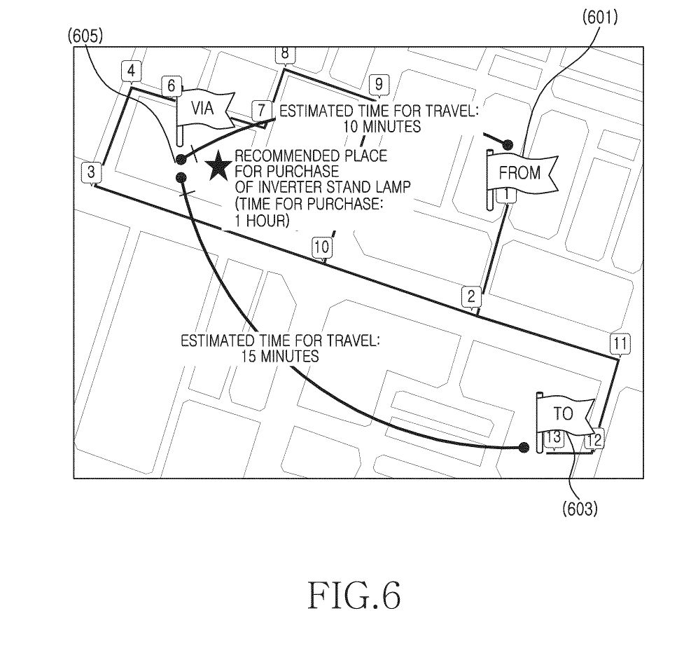

FIGS. 3A and 3B illustrate a process for providing information about a task that is performable between a first schedule and a second schedule in the electronic device according to an embodiment of the present disclosure. FIG. 4 is a diagram illustrating an example of managing a schedule and a task in an electronic device according to an embodiment of the present disclosure. FIG. 5 is a diagram illustrating a location of a performable task between a first schedule and a second schedule in an electronic device according to an embodiment of the present disclosure. FIG. 6 is a diagram illustrating a location of a performable task when location information is included in a task in an electronic device according to an embodiment of the present disclosure.

Referring to FIGS. 3A and 3B, at operation 301, the electronic device 100 detects a first schedule and a second schedule.

When the electronic device 100 detects a first schedule and a second schedule at operation 301, the electronic device 100 proceeds to operation 303 at which the electronic device 100 determines the completion time of the first schedule and the start time of the second schedule. In this case, the schedule includes time and location information, and refers to things to do by a user.

Thereafter, at operation 305, the electronic device 100 determines whether at least one task exists. In this case, the task may include any one or none of time and location information, and refers to items and/or the like to do by the user. For example, as illustrated in FIG. 4, the electronic device 100 detects the first schedule 401 and the second schedule 403, determines the completion time (8:00 pm) of the first schedule and the start time (10:00 pm) of the second schedule. Thereafter, the electronic device 100 determines a task 407 that is previously stored.

When the electronic device 100 determines that no tasks exists at operation 305, then the electronic device 100 returns to operation 301 to perform the subsequent steps again.

In contrast, when the electronic device 100 determines that at least one task exists at operation 305, the electronic device 100 proceeds to operation 307. At operation 307, the electronic device 100 searches for at least one location corresponding to the task within a threshold distance from a location associated with the first schedule and a location associated with the second schedule. In this case, the at least one location corresponding to the task represents a location at which the task may be performed. The electronic device 100 searches for a location at which the task may be performed, based on a word included in the task. For example, as illustrated in FIG. 4, when the task is “Purchasing an inverter stand lamp”, the electronic device 100 searches for an “appliance shop” at which the inverter stand lamp is sold within the threshold distance from the location associated with the first schedule and the location associated with the second schedule. As another example, when the task is “Seeing a movie”, the electronic device 100 searches for a “theater” at which a movie is screened within the threshold distance from the location associated with the first schedule and the location associated with the second schedule. As another example, when the task is “Bank account management”, the electronic device 100 searches for a “bank” at which the bank account is maintained within the threshold distance from the location associated with the first schedule and the location associated with the second schedule. In this case, the electronic device 100 may search for a location corresponding to the task based on map information and POI information stored in the memory.

Thereafter, at operation 309, the electronic device 100 determines whether at least one location corresponding to the at least one task exists.

When the electronic device 100 determines that no location corresponding to the at least one task exists at operation 309, the electronic device 100 ends the process according to the various embodiments of the present disclosure.

In contrast, when the electronic device 100 determines that at least one location corresponding to the determined task at operation 309, the electronic device 100 proceeds to operation 311. At operation 311, the electronic device 100 determines whether the task includes time information.

When the electronic device 100 determines that the task includes time information, the electronic device 100 proceeds to operation 313. At operation 313, the electronic device 100 determines the at least one location in consideration of the difference in time (hereinafter referred to as a “first time”) between the completion time of the first schedule and the start time of the second schedule, an estimated time (hereinafter referred to as a “second time”) taken to travel from the location associated with the first schedule to the location associated with the second schedule via the location corresponding to the task, and a task time. In other words, the electronic device 100 determines a location at which the sum of the second time and the task time is smaller than the first time among the at least one location corresponding to the task. When two or more locations at which the sum of the second time and the task time is smaller than the first time exist, the electronic device 100 may provide the two locations as options, and determine a selected location or a location at which the second time is shortest. For example, as illustrated in FIG. 5, the electronic device 100 may provide, as options, three locations 505, 507 and 509 corresponding to the task, at which the sum of the second time and the task time is smaller than the first time and which are placed within the threshold distance from the location 501 associated with the first schedule and the location 503 associated with the second schedule. In contrast, when one location at which the sum of the second time and the task time is smaller than the first time exists, the electronic device 100 determines the location. In this case, the electronic device 100 may calculate estimated times taken to travel with respect to respective locations based on TPEG.

Thereafter, at operation 315, the electronic device 100 outputs information about the determined location. In this case, the information about the location includes a sketch map from the location associated with the first schedule to the location corresponding to the task, and a sketch map from the location corresponding to the task to the location associated with the second schedule. In addition, the information about the location includes a first estimated time taken to travel from the location associated with the first schedule to the determined location and a second estimated time taken to travel from the determined location to the location associated with the second schedule. For example, as illustrated in FIG. 6, the electronic device 100 may output a sketch map from the location 601 associated with the first schedule to the location 603 associated with the second schedule via the location 605 corresponding to the task and a relevant travel time. Thereafter, the electronic device 100 proceeds to operation 321.

When the electronic device 100 determines that the task does not include time information in the task at operation 311, the electronic device 100 proceeds to operation 317. At operation 317, the electronic device 100 determines at least one location in consideration of the difference in time between the completion time of the first schedule and the start time of the second schedule, and an estimated time taken to travel from the location associated with the first schedule to the location associated with the second schedule via the location corresponding to the task. In other words, the electronic device 100 determines a location at which the second time is smaller than the first time among the at least one location corresponding to the task. When two or more locations at which the second time is smaller than the first time exist, the electronic device 100 may provide the two locations as options, and provide information about a selected location or a location at which the second time is shortest. In contrast, when one location at which the second time is smaller than the first time exists, the electronic device 100 provides information about the location.

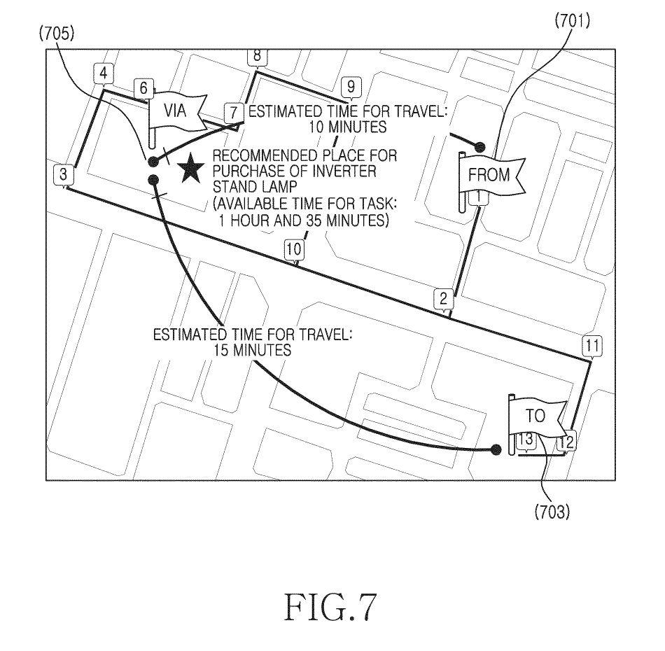

Thereafter, at operation 319, the electronic device 100 outputs information about the determined location and an available time for task performance. In this case, the electronic device 100 may determine a time calculated by subtracting the second time from the first time as the available time for task performance. For example, when the difference in time between the completion time of the first schedule and the start time of the second schedule is two hours, and the estimated time taken to travel from the location associated with the first schedule to the location associated with the second schedule via the location corresponding to the task is an hour, the electronic device 100 may output information representing that it is possible to perform the task for one hour at the determined location. For example, as illustrated in FIG. 7, the electronic device 100 may output a sketch map from the location 701 associated with the first schedule to the location 703 associated with the second schedule via the location 705 corresponding to the task and a relevant travel time, and additionally display an indication that the available time for task performance is an hour and 35 minutes. Thereafter, the electronic device 100 proceeds to operation 321.

At operation 321, the electronic device 100 determines whether the task has been performed. In this case, the electronic device 100 may determine whether the task has been performed according to user control.

When the electronic device 100 determines that the task has been performed at operation 312, the electronic device 100 proceeds to operation 323. At operation 323, the electronic device 100 determines whether another task other than the performed task exists.

When the electronic device 100 determines that another task other than the performed task exists at operation 323, the electronic device 100 proceeds to operation 325. At operation 325, the electronic device 100 determines the location of the performed task as the location associated with the first schedule, and the completion time of the performed task as the completion time of the first schedule. Thereafter, the electronic device 100 returns to operation 307 to perform the subsequent steps again.

When the electronic device 100 determines that no task other than the performed task exists at operation 323, the electronic device 100 ends the process according to the various embodiments of the present disclosure.

When the electronic device 100 determines that the task has not been performed at operation 321, the electronic device 100 proceeds to operation 327. At operation 327, the electronic device 100 determines whether another task other than the performed task exists.

When the electronic device 100 determines that another task other than the performed task exists at operation 327, the electronic device 100 returns to operation 307 to perform the subsequent steps again.

In contrast, when the electronic device 100 determines that no task other than the performed task exists at operation 327, the electronic device 100 ends the process according to various the embodiments of the present disclosure.

The various embodiments and the operations of the present disclosure described in this specification may be implemented in computer software, firmware, or hardware, including the structures disclosed in this specification and equivalents thereof, or a combination thereof In addition, the various embodiments of the present disclosure described in this specification may be implemented by one or more computer program products, for example, one or more modules of computer program instructions that are executed by a data processing device or are encoded on a non-transitory computer-readable medium for controlling an operation of the data processing device.

The non-transitory computer-readable medium may be a non-transitory machine-readable storage medium, a non-transitory machine-readable storage substrate, a memory device, a composition of material influencing a machine-readable stream, or a combination thereof. For example, the term “data processing apparatus” includes all apparatus, devices, and machines for processing data, such as programmable processors, computers, or multiple processors or computers. The apparatuses may include, in addition to hardware, codes that create an execution environment for a relevant computer program, such as codes that constitutes processor firmware, a protocol stack, a database management system, an operating system, or a combination thereof.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
detecting a first schedule and a second schedule;
detecting at least one task;
detecting at least one location corresponding to the task within a threshold distance of a location associated with the first schedule and a location associated with the second schedule;
calculating an estimated time to travel from the location associated with the first schedule to the location associated with the second schedule using the at least one detected location;
comparing the calculated estimated time with a time difference between a completion time of the first schedule and a start time of the second schedule; and
outputting information about the at least one detected location when the calculated estimated time is smaller than the time difference.

2. The method of claim 1, wherein the schedule includes time and location information and represents an activity to be done by a user.

3. The method of claim 1, wherein the task includes one or none of time and location information and represents an activity to be done by a user.

4. The method of claim 1, wherein the detecting of the at least one location corresponding to the task within the threshold distance of the location associated with the first schedule and the location associated with the second schedule comprises:
detecting a word included in the task;
determining a higher category of the detected word; and
detecting at least one location corresponding to the determined higher category.

5. The method of claim 1, wherein the calculating of the estimated time to travel from the location associated with the first schedule to the location associated with the second schedule using the at least one detected location, comprises:
calculating a first estimated time to travel from the location associated with the first schedule to the at least one detected location;
calculating a second estimated time to travel from the at least one detected location to the location associated with the second schedule; and
calculating a sum of the first estimated time and the second estimated time.

6. The method of claim 1, wherein the outputting of the information about the at least one detected location when the calculated estimated time is smaller than the time difference, comprises:
determining whether time information is included in the task;
determining an available time for task performance for which the task is performed at the at least one detected location when the time information is not included in the task; and
outputting information about the determined available time for task performance.

7. The method of claim 6, wherein the determining of an available time for task performance for which the task is performed at the at least one detected location, comprises:
calculating a spare time representing a difference between the time difference and the calculated estimated time; and
determining the calculated spare time as the available time for task performance.

8. The method of claim 1, further comprising:
determining whether the task has been performed after outputting the information about the at least one detected location;
determining a location of the performed task as the location associated with the first schedule when the task has been performed; and
determining a completion time of the performed task as a completion time of the first schedule.

9. The method of claim 8, wherein the information about the at least one detected location includes information representing that performance of the at least one detected task is possible at the at least one detected location between the first schedule and the second schedule.

10. An electronic device comprising:
at least one processor;
a touch sensitive display;
a memory; and
at least one program stored in the memory and configured to be executable by the at least one processor,
wherein the at least one program includes instructions for:
detecting a first schedule and a second schedule;
detecting at least one task;
detecting at least one location corresponding to the task within a threshold distance of a location associated with the first schedule and a location associated with the second schedule;
calculating an estimated time taken to travel from the location associated with the first schedule to the location associated with the second schedule using the at least one detected location;
comparing the calculated estimated time with a time difference between a completion time of the first schedule and a start time of the second schedule; and
outputting information about the at least one detected location when the calculated estimated time is smaller than the time difference.

11. The electronic device of claim 10, wherein the schedule includes time and location information and represents an activity to be done by a user.

12. The electronic device of claim 10, wherein the task includes one or none of time and location information and represents an activity to be done by a user.

13. The electronic device of claim 10, wherein the program further includes an instruction for:
detecting a word included in the task;
determining a higher category of the detected word; and
detecting at least one location corresponding to the determined higher category.

14. The electronic device of claim 10, wherein the program further includes an instruction for:
calculating a first estimated time to travel from the location associated with the first schedule to the at least one detected location;
calculating a second estimated time to travel from the at least one detected location to the location associated with the second schedule; and
calculating a sum of the first estimated time and the second estimated time.

15. The electronic device of claim 10, wherein the program further includes an instruction for:
determining whether time information is included in the task;
determining an available time for task performance for which the task is performed at the at least one detected location when the time information is not included in the task; and
outputting information about the determined available time for task performance.

16. The electronic device of claim 15, wherein the program further includes an instruction for:
calculating a spare time representing a difference between the time difference and the calculated estimated time; and
determining the calculated spare time as the available time for task performance.

17. The electronic device of claim 10, wherein the program further includes an instruction for:
determining whether the task has been performed after outputting the information about the at least one detected location;
determining a location of the performed task as the location associated with the first schedule when the task has been performed; and
determining a completion time of the performed task as a completion time of the first schedule.

18. The electronic device of claim 17, wherein the information about the at least one detected location includes information representing that performance of the at least one detected task is possible at the at least one detected location between the first schedule and the second schedule.

19. A method for controlling an electronic device, comprising:
detecting a first schedule and a second schedule; and
outputting information about a task that is performable between the first schedule and the second schedule among a plurality of tasks stored in the electronic device, when the first schedule is completed,
wherein the information about the task includes at least one of at least one location at which performance of the task is possible, and an available time for task performance.

20. An electronic device comprising:
at least one processor;
a touch sensitive display;
a memory; and
at least one program stored in the memory and configured to be executable by the at least one processor,
wherein the at least one program includes instructions for
detecting a first schedule and a second schedule; and
outputting information about a task that is performable between the first schedule and the second schedule among a plurality of tasks stored in the electronic device, when the first schedule is completed,
wherein the information about the task includes at least one of at least one location at which performance of the task is possible, and an available time for task performance.
